(19) United States
(12) Patent Application Publication
(10) Pub. No.: US 2026/0029587 A1
(43) Pub. Date: Jan. 29, 2026

(54) IMAGING SYSTEM WITH FIBER OPTICAL CONNECTION

(71) Applicant: CANON U.S.A., INC., MELVILLE, NY (US)

(72) Inventor: Ray Xuri Yan, Newton, MA (US)

(21) Appl. No.: 18/996,884

(22) PCT Filed: Jul. 20, 2023
(86) PCT No.: PCT/US2023/070609

§ 371 Date: Jan. 17, 2025

Related U.S. Application Data
(60) Provisional application No. 63/391,157, filed on Jul. 21, 2022.

(51) Int. Cl. G02B 6/38

(52) U.S. Cl. CPC G02B 6/3874; G02B 6/3825

(57) ABSTRACT

An optical connection system comprises a fiber optic connector, a fiber optic adapter, and a guide sleeve. The guide sleeve is coupleable with the fiber optic adapter and includes a plurality of flexible members configured to guide the fiber optic connector into the fiber optic adapter to engage the fiber optic connector with the fiber optic adapter.

### CROSS-REFERENCE TO RELATED APPLICATIONS

This application claims priority to U.S. Provisional Application No. 63/391,157, filed Jul. 21, 2022, which is hereby incorporated by reference herein in its entirety.

### BACKGROUND

### Field of the Disclosure

The present disclosure generally relates to imaging systems and optical connections and, more particularly, to a fiber optical connection in an imaging system.

### Description of the Related Art

Many imaging configurations are dependent of the use of an optic fiber to scan for imaging or other optical applications.

The field of minimally invasive medical devices includes optical imaging methods such as optical coherence tomography (OCT), spectrally encoded endoscopy (SEE), and the like. In optical fiber applications such as OCT, SEE, etc., imaging devices which use optical fiber and imaging probe rotation to scan and collect optical signals at the distal end and transmit the signals through the optical fiber to the proximal signal processing unit or the system.

A variety of optical fiber connectors are available, such as SC, LC, FC, ST, LX-5, MU, MPO, E2000, F3000, and the like. SC and LC connectors are the most common types of connectors on the market. SC is a snap-in connector that latches with a simple push-pull motion. LC is a ceramic ferrule connector with a latch style lock and is about half the size of the SC. Within these connectors, optical fiber end-faces are specified to be polished differently, with PC being polished to a flat plane, UPC with slight curvature, and APC with angled flat plane. Optical connectors are generally rated for 500-1,000 mating cycles.

In one example OCT system, the system includes an optical probe and a patient interface unit (PIU), among other features. The optical probe includes a fiber optic based catheter and a catheter handle. An LC fiber optic connector sits inside a catheter handle. A fiber optic adapter sits within the PIU. The PIU is a motor drive unit to engage and actuate the imaging core of the catheter, and is positioned close to the patient during the procedure. When the catheter handle is connected with the PIU, the center of the fiber optic connecter of the probe and the center of the fiber optic adapter of the PIU should be aligned to achieve a proper optical connection. However, during an automatic engaging operation (i.e., under computer control), where the fiber optic adapter of the PIU is driven by a linear stage to approach the fiber optic connecter on the catheter side, there is a possibility of misalignment. The misalignment is determined by the entire catheter to PIU assembly. The resulting tolerance stack-up between fiber optic connector and fiber optic adapter may cause too much misalignment, which will prevent the smooth engagement operation between the fiber optic connector on the catheter side and the fiber optic adapter on the PIU side. When there is misalignment, a collision may occur as the fiber optic connector moves toward the rear entrance of the fiber optic adapter (e.g., at the rear surface 101 of the adapter 104 in related art FIG. 9). In some systems, in order to protect the fiber end of the connector on the PIU side from damage caused by mating multiple times, a sacrificial adapter is included to mate the connector of the catheter side with the adapter of the PIU side. The sacrificial adapter does not perform an attenuating function, but physically protects the connector of the PIU side because the physical engagement and disengagement occurs at the sacrificial adapter. The sacrificial adapter may be replaced after certain number of engagements with the connector of the catheter side. When present, this sacrificial adapter adds to the length and potential misalignment on the PIU assembly side when making a connection. In other example systems, in place of the sacrificial adapter, an attenuator may be present that performs an attenuating function, i.e., is not merely sacrificial.

Therefore, there is a need in the art for an optical connection system that compensates for misalignment when a fiber optic connector on the catheter side is mated with a fiber optic adapter on the PIU side using an automatic engaging operation, whether a sacrificial adapter is included or not included.

### SUMMARY

The fiber optic connection disclosed herein applies to a system having a fiber optic connector and an adapter either having a sacrificial adapter (i.e., connector-sacrificial adapter pair) or not.

According to an aspect of the present disclosure an optical connection system comprises a fiber optic connector, a fiber optic adapter, and a guide sleeve. The guide sleeve is coupleable with the fiber optic adapter and includes plurality of flexible members configured to guide the fiber optic connector into the fiber optic adapter to engage the fiber optic connector with the fiber optic adapter.

According to another aspect of the present disclosure, an imaging system comprises an imaging console, an optical probe including a fiber optic connecter, a patient interface unit (PIU) for connecting the optical probe to the imaging console, the PIU including a fiber optic adapter; and a stage for moving at least one of the optical probe and the patient interface unit toward the other. The fiber optic connecter includes a fiber optic connector housing. The fiber optic adapter includes a fiber optic adapter housing, and a guide sleeve coupled with the fiber optic adapter, the guide sleeve including a plurality of flexible members configured to guide the fiber optic connector into the fiber optic adapter to engage the fiber optic connector with the fiber optic adapter.

According to another aspect of the present disclosure, a method of making an optical connection comprises moving at least one of a fiber optic connecter and a fiber optic adapter toward the other. The fiber optic connector includes a fiber optic connector housing. The fiber optic adapter includes a fiber optic adapter housing that receives and accommodates the first fiber optic connector and a guide sleeve coupled with the fiber optic adapter, the guide sleeve including a plurality of flexible member. The method further includes guiding, via the guide sleeve, the fiber optic connector into the fiber optic adapter such that the fiber optic connector engages with the fiber optic adapter.

Further features of the present disclosure will become apparent from the following description of exemplary embodiments with reference to the attached drawings, where like structure is indicated with like reference numerals.

### BRIEF DESCRIPTION OF THE DRAWINGS

FIG. 1 shows an exemplary medical imaging system in which the optical connector system of either of the first example embodiment or the second example embodiment may be implanted.

FIG. 2 shows a partial detached side view of a portion of FIG. 1 where an optical connection resides within the medical imaging system, with omissions, in accordance with a first example embodiment.

FIG. 3 shows a partially exploded side view of a portion of FIG. 2 where the optical connection is separated into portions.

FIG. 4 shows a close up side view of a portion of FIG. 3.

FIG. 5 shows a further exploded view of the optical connection of FIG. 4.

FIG. 6 shows a rear view of a related art fiber optic connector.

FIG. 7 shows a cross section of the fiber optic connector taken along line 7-7 of FIG. 6.

FIG. 8 shows a side perspective view of the fiber optic adapter without a guide sleeve.

FIG. 9 shows a rear perspective of a related art sacrificial adapter without the guide sleeve.

FIG. 10 shows a rear view of the sacrificial adapter without the guide sleeve.

FIG. 11 shows a cross section view of the sacrificial adapter without the guide sleeve, taken along line 11-11 of FIG. 10, in accordance with the first example embodiment.

FIG. 12 shows a side perspective view of a guide sleeve without being coupled to the sacrificial adapter.

FIG. 13 shows a rear view of the guide sleeve without being coupled to the sacrificial adapter.

FIG. 14 shows a side rear perspective view of the guide sleeve coupled with the sacrificial adapter, in accordance with the first example embodiment.

FIG. 15 shows a bottom-side perspective view of the guide sleeve coupled with the sacrificial adapter, in accordance with the first example embodiment.

FIG. 16 shows a rear view of the guide sleeve coupled with the sacrificial adapter, in accordance with the first example embodiment.

FIG. 17 shows a cross section of the guide sleeve coupled with the sacrificial adapter taken along line 17-17 of FIG. 16.

FIG. 18 shows a side view of a step of inserting the fiber optic connecter into the sacrificial adapter, in accordance with the first example embodiment.

FIG. 19 shows a schematic cross section in the process of connecting the fiber optic connecter with the sacrificial adapter when an approach of the fiber optic connector is off-center, in accordance with the first example embodiment.

FIG. 20 shows a schematic cross section in the process of connecting the fiber optic connecter with the sacrificial adapter after a portion of the fiber optic connecter has been inserted into the sacrificial adapter, in accordance with the first example embodiment.

FIG. 21 shows a schematic cross section in the process of connecting the fiber optic connecter with the sacrificial adapter after the fiber optic connector has been fully inserted into the sacrificial adapter, in accordance with the first example embodiment.

FIG. 22 shows a side view in the process of connecting the fiber optic connecter with the sacrificial adapter after the fiber optic connector has been fully inserted into the sacrificial adapter, in accordance with the first example embodiment.

FIG. 23 shows a partial detached side view of a portion of FIG. 1 where an optical connection resides within the medical imaging system, with omissions, in accordance with a second example embodiment.

FIG. 24 shows a partially exploded side view of a portion of FIG. 23, where the optical connection of the second example embodiment is separated into portions.

FIG. 25 shows a close up side view of a portion of FIG. 24.

FIG. 26 shows a side perspective view of a related art fiber optic adapter present in the example embodiments.

FIG. 27 shows a rear perspective view of the fiber optic adapter of FIG. 26.

FIG. 28 shows a rear view of the fiber optic adapter of FIG. 26.

FIG. 29 shows a cross-section view of the fiber optic adapter of FIG. 26 taken along line 29-29 of FIG. 28.

FIG. 30 shows a side view in the process of connecting the fiber optic connecter with the fiber optic adapter before the fiber optic connector has been fully inserted into the fiber optic adapter, in accordance with the second example embodiment.

FIG. 31 shows a side view in the process of connecting the fiber optic connecter with the fiber optic adapter after the fiber optic connector has been fully inserted into the fiber optic adapter, in accordance with the second example embodiment.

FIG. 32 shows a perspective view of a guide sleeve in accordance with a third example embodiment.

FIG. 33 shows a perspective view of the fiber optic connecter with the sacrificial adapter after the fiber optic connector has been fully inserted into the sacrificial adapter, with the guide sleeve of FIG. 32.

FIG. 34 shows a perspective view of the fiber optic connecter, the fiber optic adapter, the sacrificial adapter, and the guide sleeve of FIG. 32, after the fiber optic connector has been fully inserted into the sacrificial adapter.

### DESCRIPTION OF THE EMBODIMENTS

Various exemplary embodiments, features, and aspects of the disclosure will be described below with reference to the drawings.

In the following embodiments, optical connector or connection configurations are described to provide optical or electrical communication that may have different characteristics, advantages, disadvantages, performance parameters, or the like. The present disclosure is not limited to any particular configuration.

Optical connection configurations or assemblies described below according to one or more aspects of the present disclosure generally make use of one or more optical connectors that can accommodate any single mode or multi-mode fiber, can have flat (PC, UPC) or angled (APC) ferrule end faces, and can be any suitable type of connector including, for example, SC, LC, FC, ST, PC, UPC, APC, LX-5, MU, MPO, or the like. SC and LC connectors are the most common types of connectors on the market. SC is a snap-in connector that latches with a simple push-pull motion. LC is a ceramic ferrule connector with a latch style lock and is about half the size of the SC. While an LC configuration is shown and described herein as a particular example, it should be understood that the concepts are applicable to any of the above-listed connector types.

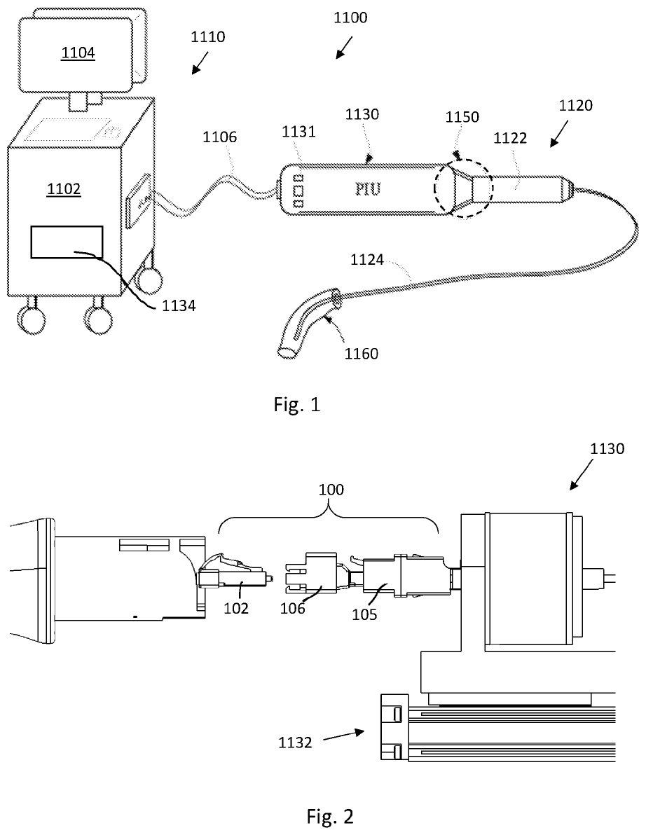

FIG. 1 shows an exemplary medical imaging system 1100 in which the optical connector system may be implanted. The medical imaging system 1100 includes an imaging console 1110 and an optical probe 1120 (e.g., endoscope or catheter). A patient interface unit (PIU) 1130 connects the optical probe 1120 to the imaging console 1110 using a cable bundle 1106. The imaging console 1110 includes, among other things, a system cart 1102 and one or more displays 1104. The optical probe 1120 may include, for example, a fiber-optic based catheter 1124 and a catheter handle 1122. In an exemplary imaging procedure, the imaging system 1100 uses the catheter 1124 to obtain images of an imaging sample 1160, such as a cardiovascular or bodily lumen of a patient. The PIU 1130 further includes a linear stage 1132 configured to linearly translate the adapter toward or away from the connector inside the probe 1120 as part of an automatic engaging or disengaging operation. The imaging system 1100 may also include a controller 1134 (e.g., a computer, CPU, processor, etc.) inside the system cart 1102 to receive and operate instructions to perform the engaging or disengaging operation. A motor driver (not shown) may be integrated into the PIU 1130 in an embodiment. Which unit is integrated into the system cart or the PIU is a variable depending on the space and system design.

The PIU 1130 is the main interface between the catheter and the console 1110. The console 1110 and PIU 1130 are connected by the PIU cable bundle 1106. The cable bundle 1106 houses therein cables for transmitting electrical power and for communication signaling, as well as optical fibers for light transmission.

The PIU 1130 is generally composed of a motion mechanism including a linear stage, and a catheter receptacle area 1150 where the optical probe 1120 is physically connected and with the PIU 1130 and optically coupled inside. The improved optical connection described herein is this internal optical connection between the optical probe 1120 and the PIU 1130.

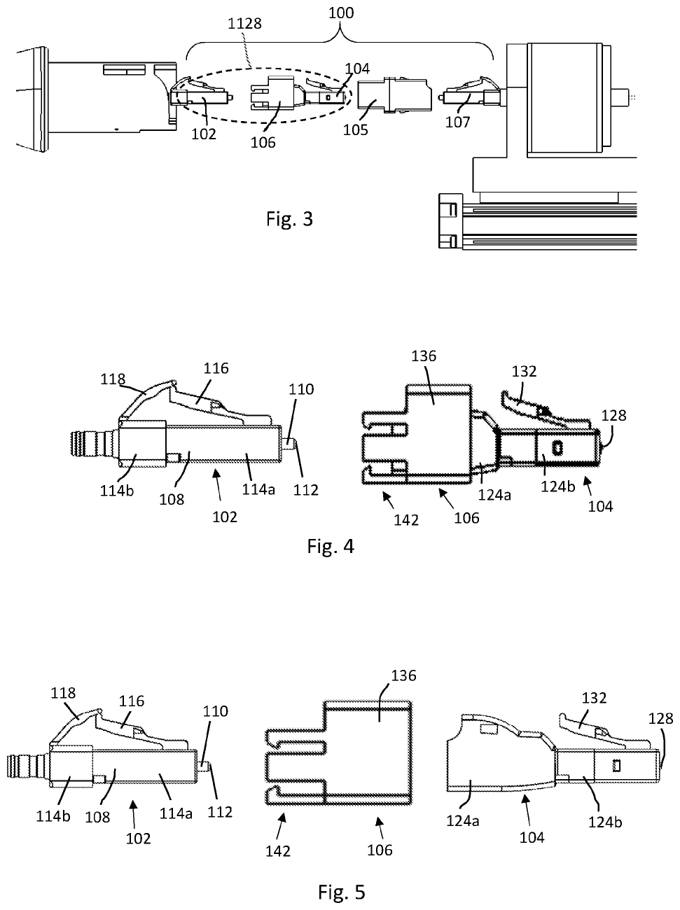

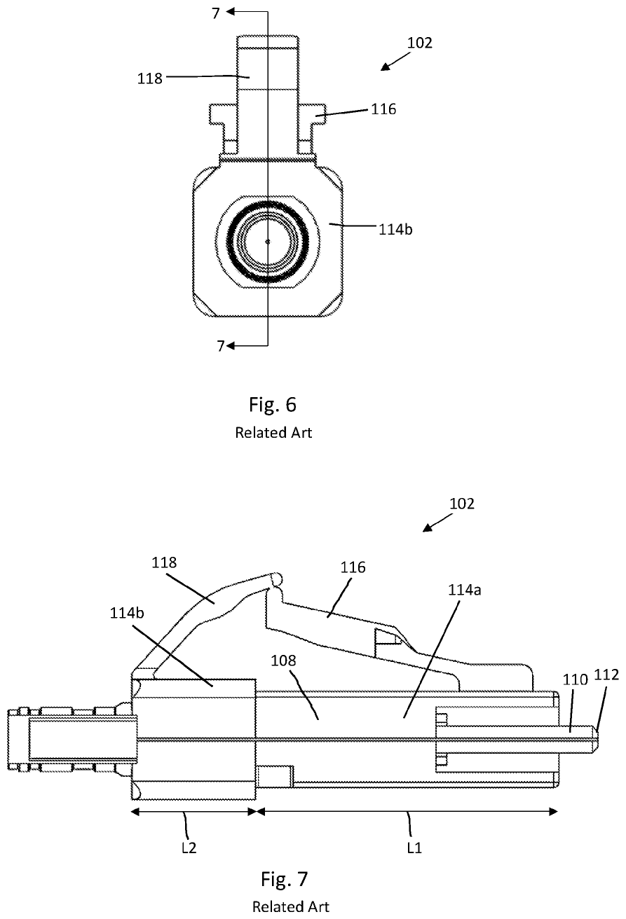

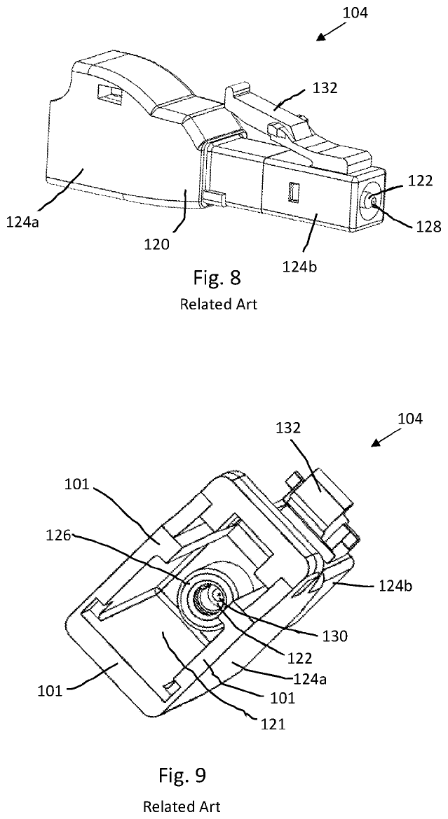

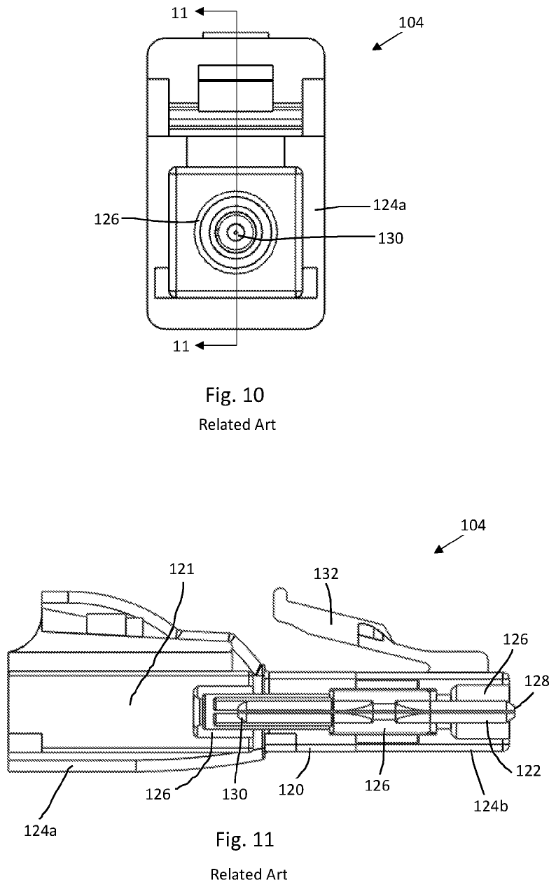

FIG. 2 shows a partial detached side view of a portion of FIG. 1 where the optical connection resides within the medical imaging system 1100. In FIG. 2, the catheter handle 1122 of the optical probe 1120 is shown separated from the PIU 1130 and some of the structure of the PIU 1130 is omitted, such that the optical connection 100 is visible. FIG. 3 shows a partially exploded side view of FIG. 2 where the optical connection 100 is separated into components. As shown in FIG. 3, the components of the optical connection 100 include a first fiber optic connector 102 on the probe side, a sacrificial adapter 104 (also known as a o-dB attenuator), where the sacrificial adapter 104 is coupled with a guide sleeve 106, a fiber optic adapter 105 on the PIU side, and a second fiber optic connector 107 on the PIU side. In another example embodiment, instead of a sacrificial adapter 104 (so-called because it does not serve an attenuating function), may be replaced by a functioning attenuator, i.e., an adapter that serves an attenuating function. All of the structure and function of the components described herein that interact with the sacrificial adapter are also applicable to an adapter having an attenuating function.

FIG. 7 shows a cross section of the first fiber optic connector 102. As best seen in FIGS. 4 and 5 the housing 108 has a stepped profile including a first portion 114a and a second portion 114b, where the second portion 114b has a larger outer perimeter than the first portion 114a. Each of the first portion 114a and the second portion 114 may have a substantially square cross section. The second portion 114b is located toward the rear of the fiber optic connector 102 and have a length L2.

The sacrificial adapter 104 generally includes a housing 120. The housing 120 includes a first section 124a with a size and shape tailored to receive the first portion 114a of the first fiber optic connector 102. The housing 120 includes a second section 124b with a size and shape tailored connect with the fiber optic adapter 105. During the engaging process, PIU linear stage drives toward optic connector 102, 114a is inserted into the sacrificial adapter 104 and the engagement process is completed.

As described above, it should be understood that from the perspective of performing a particular procedure of this disclosure, the sacrificial adapter 104 is already coupled with the fiber optic adapter 105 on the PIU before the PIU is coupled with the probe.

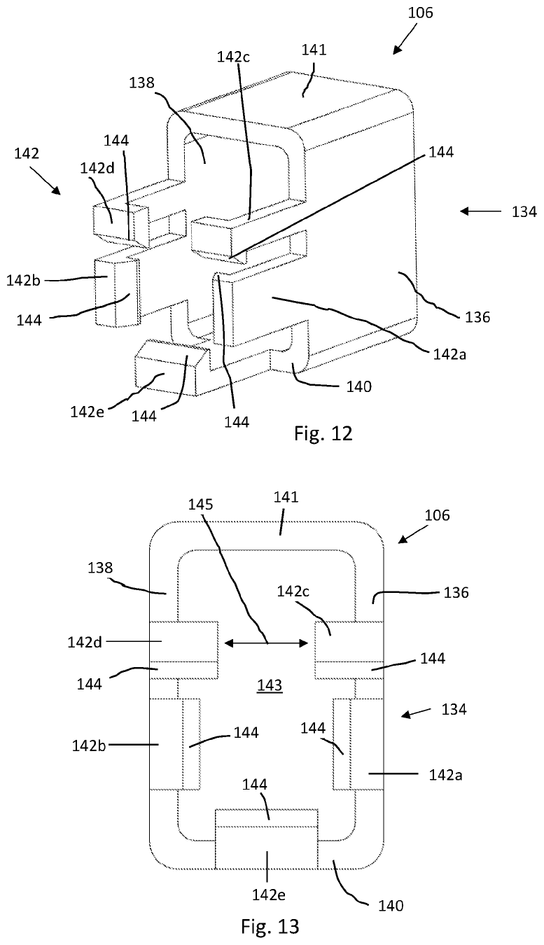

FIG. 12 shows a side perspective view of the guide sleeve 106 without being coupled to the sacrificial adapter 104. FIG. 13 shows a rear view of the guide sleeve 106 without being coupled to the sacrificial adapter 104. The guide sleeve 106 generally comprises a main body 134. The main body 134 is sized and shaped to fit tightly around the rear end of the first portion 124a of the housing 120 of the sacrificial adapter 104. The main body 134 has a first lateral side 136, an opposing second lateral side 138, a first transverse side 140 connecting a bottom edge of the two lateral sides to each other, and an opposing second transverse side 141 connecting a top edge of the two lateral sides to each other, thus forming a rectangular shape. The first lateral side 136, the opposing second lateral side 138, the transverse side 140, and the opposing second transverse side 141 thus define a cavity 143. Because the guide sleeve 106 has a tight fit around the sacrificial adapter 104, the profile is small enough for the combination of sacrificial adapter 104 and guide sleeve 106 to fit within the limited space of the PIU 1130.

The guide sleeve 106 further includes a plurality of flexible members 142 extending from the rear end of the main body 134. In the example embodiment shown in the figures, the plurality of flexible members 142 includes five flexible members. A first flexible member 142a and a third flexible member 142c each extend from the first lateral sidewall 136, a second flexible member 142b and a fourth flexible member 142d extend from the second lateral sidewall 138, and a fifth flexible member 142e extends from the transverse side 140. Each of the plurality of flexible members 142 include a sloped portion 144. Each sloped portion 144 is angled such that when the front end of the first portion 114a of fiber optic connector 102 comes into contact with one of the plurality of flexible members 142, the fiber optic connector 102 is guided to align with a center insertion channel 121 of the sacrificial adapter 104 for a successful engagement, which is discussed in more detail below. Each sloped portion is sloped toward a longitudinal center of the cavity 143/guide sleeve 106. As shown in FIGS. 12 and 13, the first flexible member 142a opposes the second flexible member 142b, while the third flexible member 142c and the fourth flexible member 142d opposes the fifth flexible member 142e. Furthermore, as best seen in FIG. 13, an opening 145 is provided between the third flexible member 142c and the fourth flexible member 142d. This opening 145 provide space for the latch 116 of the first fiber optic connector 102 to pass into and engage with the sacrificial adapter 104. The plurality of flexible members 144 work together to push the fiber optic connecter 102 toward the center insertion channel 121 of the sacrificial adapter 104, which facilitates engagement of the fiber optic connecter 102 with the sacrificial adapter 104.

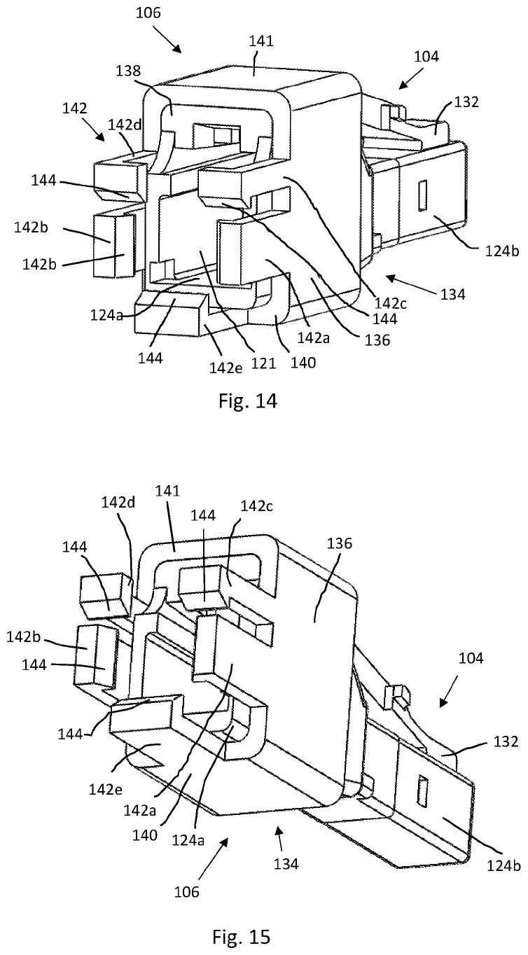

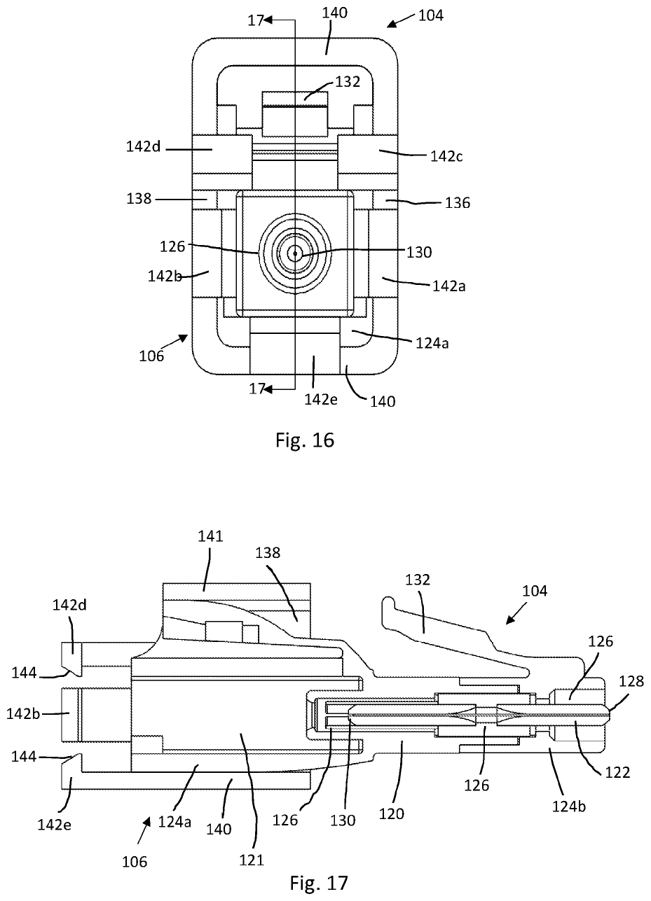

FIG. 14 shows a side rear perspective view of the guide sleeve 106 coupled with the sacrificial adapter 104. FIG. 15 shows a bottom-side perspective view of the guide sleeve 106 coupled with the sacrificial adapter 104. FIG. 16 shows a rear view of the guide sleeve 106 coupled with the sacrificial adapter 104. FIG. 17 shows a cross section of the guide sleeve 106 coupled with the sacrificial adapter 104 taken along line 17-17 of FIG. 16.

The guide sleeve 106 is coupled (or assembled) with the sacrificial adapter 104 on PIU. The dimensions of the guide sleeve 106 is chosen such that the inner dimensions of the guide sleeve 106 matches closely to the outer dimesons of the first section 124a of the sacrificial adapter 104. That is, the dimesons of the guide sleeve 106 may be selected such the inner dimensions of the guide sleeve 106 tightly fits around the outer surface of the first section 124a of the sacrificial adapter 104. In this manner, the guide sleeve 106 may be friction fit/press fit onto the sacrificial adapter 104. The guide sleeve 106 may also be attached to the sacrificial adapter 104 via an adhesive or a mechanical mechanism. In another embodiment, the structure of the guide sleeve, and in particular, the plurality of flexible members 142, may be integrally formed with the sacrificial adapter 104 instead of being a separate removable sleeve. As best seen in FIGS. 14, 15, and 17, once the guide sleeve 106 has been coupled with the sacrificial adapter 104, the plurality of flexible members 142 extend behind the rear end of the first section 124a of the sacrificial adapter 104.

As noted above, in an example embodiment the guide sleeve 106 is already coupled with sacrificial adapter 104 prior to connecting the first fiber optic connector 102 with the sacrificial adapter. In general, the first fiber optic connecter 102 is not engaged with the sacrificial adapter 104 at the beginning of, or in preparation for, performing a medical procedure. That is, the first fiber optic connecter 102 needs to be engaged with the sacrificial adapter 104 in order to optically connect the PIU 1130 with the handle 1122 of the optical probe 1120. Because the sacrificial adapter 104 is already coupled to one end of the fiber optic adapter 105, and the second fiber optic connecter 107 is coupled to the other end of the fiber optic adapter 105, the engagement of the first fiber optic connector 102 with the sacrificial adapter 104 places the optical probe 102 into optical communication with the PIU 1130. The first fiber optic connector 102 is disengaged from the fiber sacrificial adapter 104 after completing the medical procedure. After the medical procedure is performed, the fiber optic connector 102 is disengaged from the sacrificial adapter 104, so that the handle 1122 of the optical probe 1120 can be separated from the PIU 1130. As noted above, this engagement and disengagement may be performed automatically by activating the linear stage 1132.

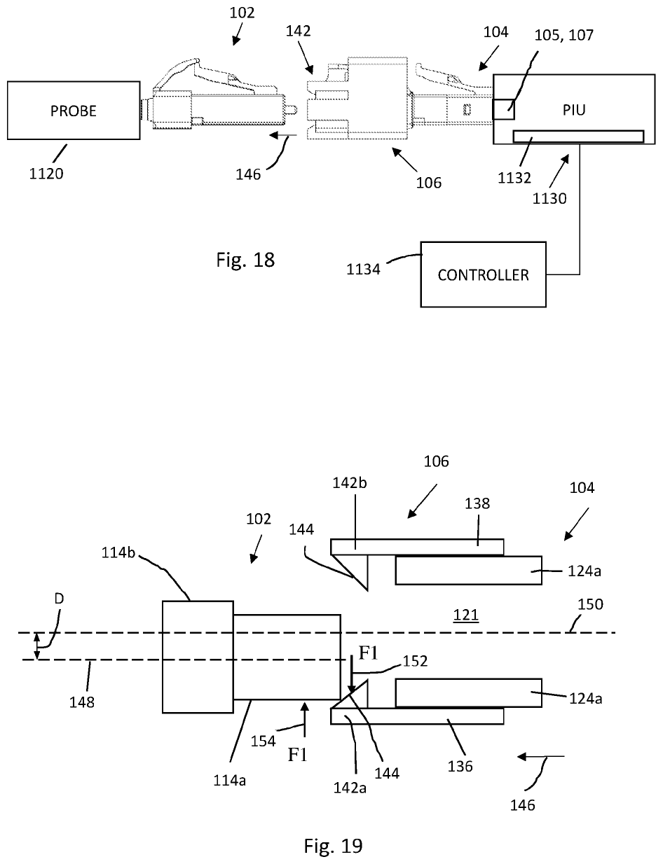

FIG. 18 shows a side view of a step of inserting the first fiber optic connecter 102 into the sacrificial adapter 104. At the moment shown in FIG. 18, the sacrificial adapter 104 having the guide sleeve 106 coupled is already connected to the fiber optical adapter 105 (not shown in FIG. 18). Similarly, the first fiber optic connector 102 is already connected to the probe 1120. As shown in FIG. 18, the sacrificial adapter 104 is advanced in a direction 146 toward the first fiber optic connector 102. The sacrificial adapter 104 with guide sleeve 106 (along with the linear stage 1132 of the PIU 1130) may be advanced automatically under the command of the controller 1134, based on instructions from an operator. That is, preferably, the steps for connecting the first fiber optic connector 102 with the sacrificial adapter 104 (thereby providing an optical connection from the probe 1120 to the PIU 1130) is performed entirely automatically without the need for a person to physically perform the connection. While FIGS. 18-21 show the sacrificial adapter 104 being translated in the direction 146 toward the first fiber optic connector 102, in another example embodiment, the first fiber optic connecter 102 may be translated toward the sacrificial adapter 104 (i.e., in a direction opposite to direction 146). In yet another embodiment, both the first fiber optic connecter 102 and the sacrificial adapter 104 may be translated toward each other simultaneously.

As noted above, a potential difficulty in making the connection is introduced when the connection is performed automatically. FIG. 19 shows a schematic cross section in the process of connecting the first fiber optic connecter 102 with the sacrificial adapter 104 when an approach of the first fiber optic connector 102 is off the center of the sacrificial adapter 104. In particular, in the example shown in FIG. 19, the longitudinal center axis 148 of the first fiber optic connecter 102 is a distance D from the longitudinal center axis 150 of the sacrificial adapter 104. As shown in FIG. 19, because the first fiber optic connector 102 is off-center by the distance D, the first portion 114a of the first fiber optic connector 102 will come into contact with one flexible member of the plurality of flexible members 142 as the linear stage continues to advance the sacrificial adapter 104 in the direction 146. In the particular example shown in FIG. 19, the contact occurs at the flexible member 142b. However, it should be understood that the first portion 114a of the first fiber optic connector 102 could come into contact with any flexible member of the plurality of flexible members 142 depending on the particular dimension of the offset.

Once the first portion 114a of the first fiber optic connector 102 comes into contact with one of the flexible members 142, a force F1 is imparted in an outward direction 152 (downward in the orientation shown in FIG. 19). At the same time the flexible member provides a corresponding equal force F1 in a direction 154 directly opposite the direction 152. The material and thickness of the flexible member 142b may be particularly tailored based on the amount of force F1 that is imparted due to the insertion force. That is, the material and thickness may be selected so that there is sufficient rigidity to resist movement against the force F1 imparted in the direction 152. Because the flexible member 142b has enough strength to resist movement from the force F1 in direction 152, the sloped portion 144 acts as ramp or a chamfered end face to guide the fiber optic connecter 102 to the optimal alignment for establishing the optical connection. That is, as the linear stage continues to impart the insertion force on the first fiber optic connecter 102 in the direction 146, the sloped portion 144 of the flexible member 142b causes the longitudinal centerline 148 of the first fiber optic connecter 102 to overlap with the longitudinal centerline 150 of the sacrificial adapter 104. Therefore, by having the sloped portion 144 acting as a ramp or a chamfered end face, even there if there is some misalignment between the fiber optic connecter 102 and the sacrificial adapter 104, the fiber optic connecter 102 will smoothly enter the sacrificial adapter 104 without a forceful collision.

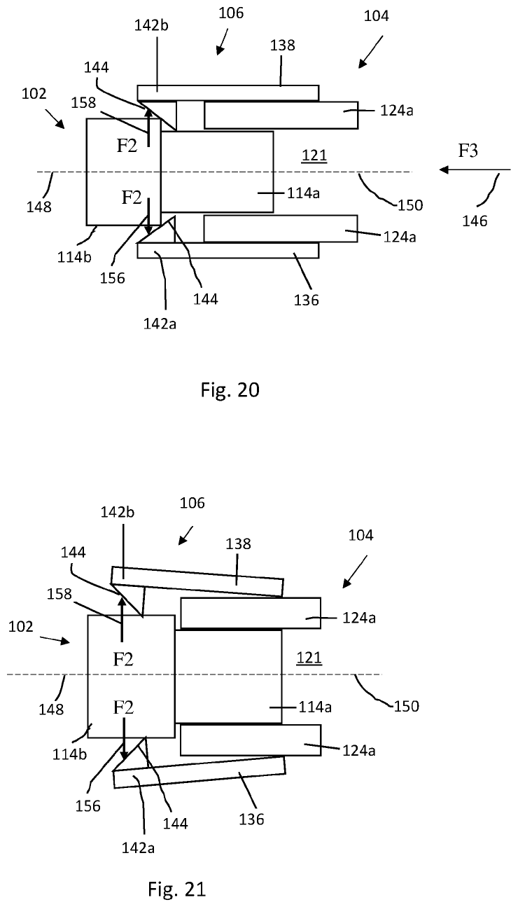

FIG. 20 shows a schematic cross section in the process of connecting the first fiber optic connecter 102 with the sacrificial adapter 104 after the first portion 114a has been inserted into the sacrificial adapter 104. The moment shown in FIG. 20 is after the sloped portion 144 of the flexible member 142b has served the function of redirecting the first fiber optic connecter 102 such that the longitudinal axis 148 of the first fiber optic connecter 102 overlaps with the longitudinal axis 150 of the sacrificial adapter 104, i.e., such that D is zero and the first fiber optic connecter 102 is optimally aligned with the sacrificial adapter 104. In the state show in FIG. 20, the first fiber optic connecter 102 has also been inserted until the point where the second portion 114b of the first fiber optic connecter 102 begins to come into contact with the sloped portion 144 of multiple flexible members. In the cross section view shown in FIG. 20, the second portion 114b of the first fiber optic connecter 102 is seen contacting the flexible member 142b and the flexible member 142d. However, it should be understood that once the first fiber optic connector 102 is properly aligned with the sacrificial adapter 104, the second portion 114b of the fiber optic connecter 102 will come into contact with all of the plurality of flexible members 142

As the inserting force F3 is continued to be applied to the first fiber optic connecter 102 in the direction 146, the second portion 114b of the first fiber optic connecter 102 will impart a force F2 in a direction outwardly on the plurality of flexible members 142. In the cross section view shown in FIG. 20, the force F2 is visible in the direction 156 against the flexible member 142b and also in the direction 158 against the flexible member 142d. However, the same force F2 would also be applied to the other flexible members in an outward direction that are not visible in FIG. 20. Unlike the force F1, the force F2 is strong enough to overcome the retaining force of the flexible members 142. That is, the magnitude of the force imparted by F2 is greater than the force F1 and is strong enough to flex the flexible members 142 outwardly. FIG. 20 shows the moment just before the force F2 moves the flexible members 142b, 142d outwardly.

The material and thickness of the flexible member 142b may be further particularly tailored based on the amount of force F2 that is imparted due to the insertion force F3. That is, the material and thickness may be selected so that there is sufficient flexibility to flex outwardly when the force F2 is imparted in the outward directions (e.g., directions 156, 158). Because the flexible member 142b is not strong enough to resist movement from the force F2 in direction 156, the sloped portion 144 does not act as ramp and instead flexes outward. The same is true for the flexible member 142d and the other flexible members not visible in FIG. 20.

For example, each of the flexible members 142 may be made of a plastic such as acrylonitrile butadiene styrene (ABS) plastic and the thickness may be 0.5 to 3 mm. When correctly selected, the combination of material and thickness will allow the same flexible members 142 to stay rigid to act as a guidance ramp when the first portion 114a of the first fiber optic connecter 102 imparts the force F1 on the flexible members 142, but also flex outwardly when the second portion 114b of the first fiber optic connector 102 imparts the force F2 on the flexible members 142.

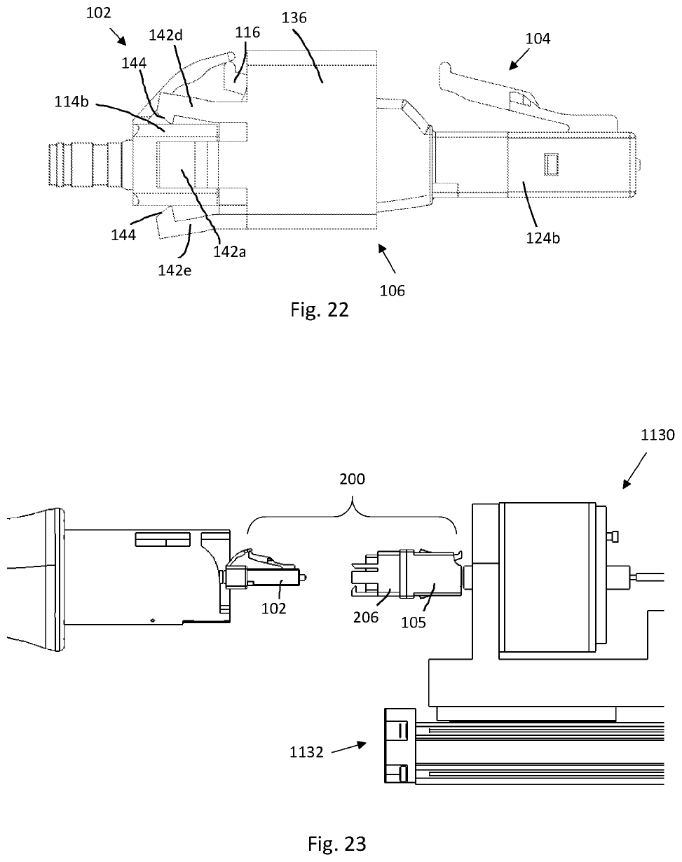

FIG. 21 shows a schematic cross section in the process of connecting the first fiber optic connecter 102 with the sacrificial adapter 104 after the first fiber optic connector 102 has been fully inserted into the sacrificial adapter 104. FIG. 22 shows a side view of the first fiber optic connector 102 fully inserted into the sacrificial adapter 104. As shown in FIGS. 21 and 22, in the fully inserted configuration, the first portion 114a of the first fiber optic connecter 102 is fully inserted into the sacrificial adapter 104, while the second portion 114b of the first fiber optic connecter 102 abuts the rear end of the sacrificial adapter 104. At the same time, the plurality of flexible members 142 are in flexed position and in contact with the second portion 114b of the first fiber optic connecter 102.

Because of the structure of the guide sleeve 106, and more particularly because of the plurality of flexible members 142, the controller 1134 is able to automatically connect the probe 1120 with the PIU 1130 and achieve a proper optical connection. That is, as discussed above with respect to FIG. 19, even if the sacrificial adapter 104 approaches the first fiber optic connecter 102 imperfectly, the guide sleeve 106 reorients either the first fiber optic connecter 102 or the sacrificial adapter 104 into the proper position while also accommodating the larger second portion 114b of the first fiber optic connecter 102.

Once the optical connection is made between the probe 1120 and PIU 1130, the medical procedure may be performed. That is, the operator may use the catheter 1124 to take images the imaging sample 1160 of the patient.

After the medical procedure is completed, the controller 1134 may then disconnect the probe 1120 from the PIU 1130. The removal step is performed by using the linear stage 1132 to move the sacrificial adapter 104 in a direction opposite the direction 146 with enough force F4 to overcome the friction force imparted by the plurality of flexible members 142 pressing against the second portion 114b. At the point of full insertion, the plurality of flexible members 142 continue to impart a force inwardly against the second portion 114b of the first fiber optic connecter 102. Therefore, when the removal force F4 is larger than the friction force caused by the plurality of flexible members 142, the first optic fiber connecter 102 will slide out of the sacrificial adapter 104, thereby disconnecting the optical connection. In the case of the probe 1120 being moved while the PIU 1130 is stationary, then the same process would occur except that the force F4 would be applied by using the linear stage 1132 to move the probe 1120 in the direction 146 toward from the PIU 1120. It is noted that if there is a lock mechanism between the first optic fiber connecter 102 and the sacrificial adapter 104, it should be disabled or unlocked prior to the automatic disengagement operation.

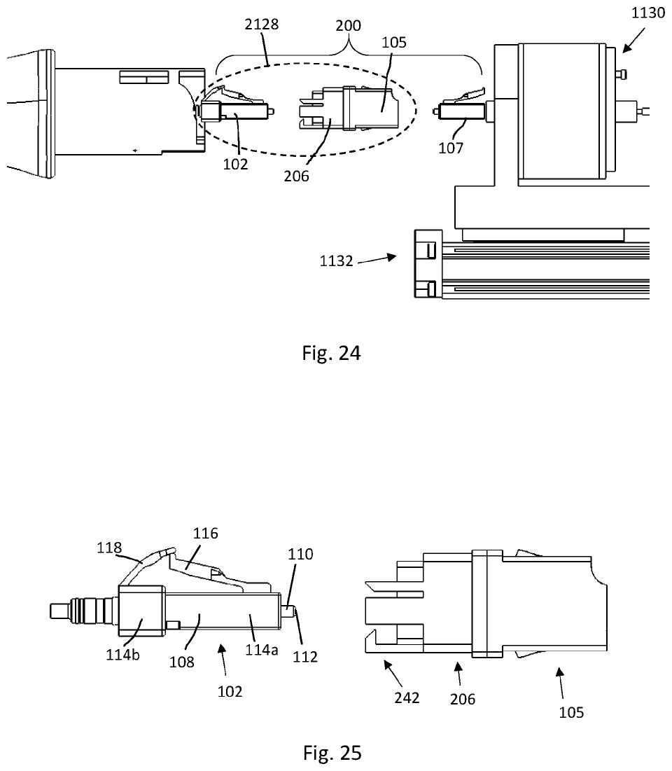

FIG. 23 shows a partially exploded side view of a portion of FIG. 1 where an optical connection 200 according to a second example embodiment resides within the medical imaging system 1100, with omissions. FIG. 24 shows a partially exploded side view of a portion of FIG. 23, where the optical connection 200 of the second example embodiment is separated into portions.

The second example embodiment implements the same principle as the first example embodiment described above, except that the sacrificial adapter is omitted. In the second example embodiment, because there is no sacrificial adapter, the guide sleeve 206 is coupled or integrated with the fiber optic adapter 105. As shown in FIGS. 23 and 24, the components are essentially the same in both example embodiments, except for the sacrificial adapter being absent. Thus, the system in the second example embodiment similarly includes the same first fiber optic connecter 102, the same fiber optic adapter 105 and the same second fiber optic connecter 107, each located in the same relative position as in the first example embodiment.

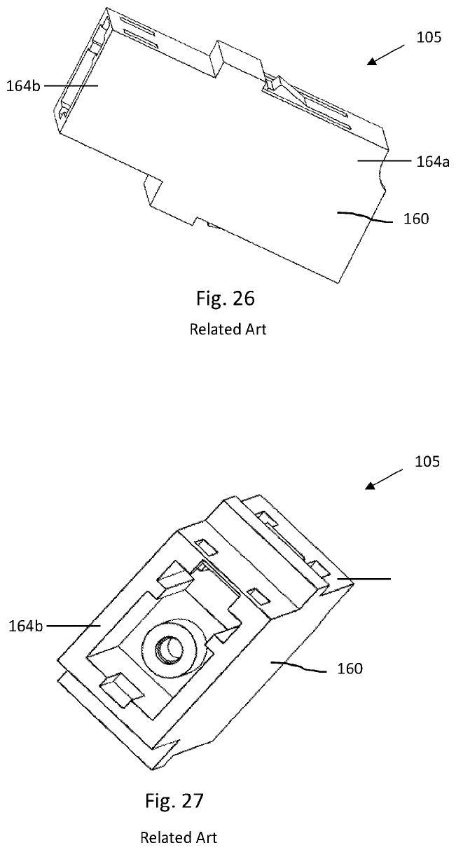

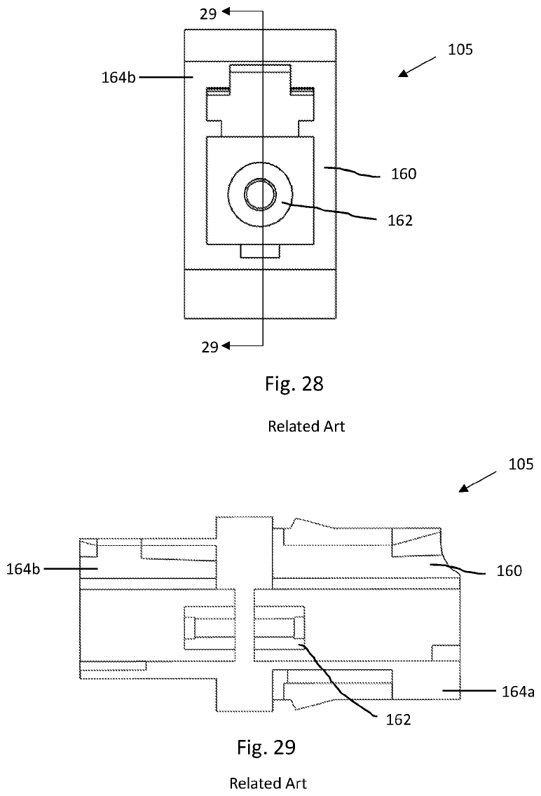

FIG. 25 shows a close up side view of a portion 2128 of FIG. 24. As shown in FIG. 25, the guide sleeve 206 is coupled or integrated with the fiber optic adapter 105 and there is no sacrificial adapter present. FIG. 26 shows a side perspective view the fiber optic adapter 105. As noted above, the fiber optic adapter 105 in the second example embodiment has the same structure as the fiber optic adapter 105 in the first example embodiment. The details of the fiber optic adapter 105 are provided with respect to the second example embodiment because the guide sleeve 106 is coupled or integrated with the fiber optic adapter 105 in the second example embodiment. Thus, while the structural details were not mentioned above, it should be understood that all of the structure described with reference to FIGS. 26 to 29 are equally applicable to the fiber optic adapter 105 in the first example embodiment.

The guide sleeve 206 in the second example embodiment is implemented in the same manner as discussed above in the first example embodiment, except that the guide sleeve 206 is coupled or integral with the fiber optic adapter 105 instead of the sacrificial adapter (the sacrificial adapter being absent in the second example embodiment). FIGS. 23, 24, and 25 show the guide sleeve 206 coupled or integrated with the fiber optic adapter 105. The guide sleeve 206 of the second example embodiment has essentially the same structure of the guide sleeve 106 of the first example embodiment, except that the size of certain elements are modified in order to account for the guide sleeve 206 being couple or integrated with the fiber optic adapter 105 instead of the sacrificial adapter, which is discussed below in more detail. While only a side view of the guide sleeve 206 is illustrated for the second example embodiment for simplicity, it should be understood that the perspective view of the guide sleeve 206 would be same as shown in FIG. 12 and the rear view would be the same as shown in FIG. 13.

As with the guide sleeve 106 of the first example embodiment, the guide sleeve 206 similarly comprises a main body having rectangular cross section sized and shaped to fit tightly around the rear end of the section 164b of the housing 160 of the fiber optic adapter 105. The main body has the same lateral sides and transverse side to form the rectangular shape. As in the first example embodiment, because the guide sleeve 206 has a tight fit around the fiber optic adapter 105, the profile is small enough for the combination of fiber optic adapter 105 and guide sleeve 206 to fit within the limited space of the PIU 1130.

As with the guide sleeve 106 of the first example embodiment, the guide sleeve 206 further includes a plurality of flexible members 242 extending from the rear end of the main body. The plurality of flexible members 242 may include the same number of flexible members, extend from the same sides, have the same sloped portions, and define the same openings as in the guide sleeve 106 of the first example embodiment.

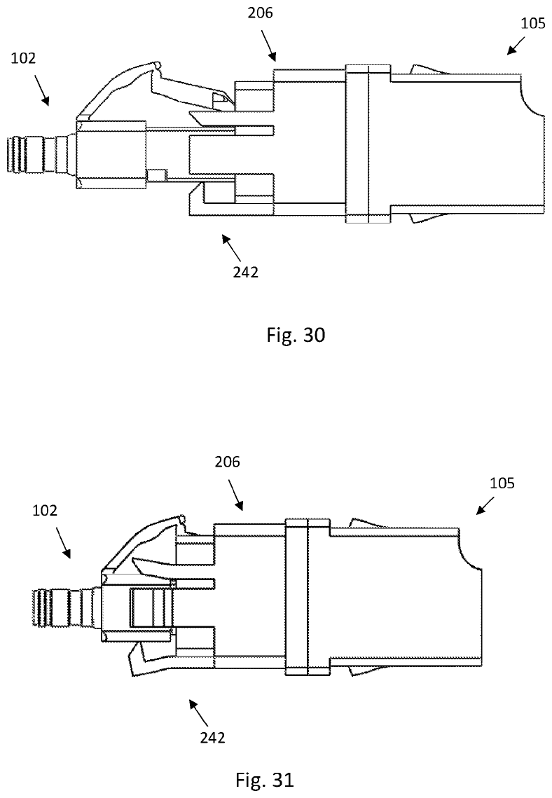

FIG. 30 shows a side view of the guide sleeve 206 coupled with the fiber optic adapter 105, when the first fiber optic connector 102 is fully engaged with the fiber optic adapter 105. The guide sleeve 206 may be coupled or integrated with the fiber optic adapter 105 in the same manner as discussed above with respect to the guide sleeve 106 of the first example embodiment. The dimensions of the guide sleeve 206 relative to the fiber optic adapter 105 may be the same as discussed above with respect to the guide sleeve 106 in the first example embodiment. The process of the engaging the first fiber optic connecter 102 with the fiber optic adapter 105 is the same as discussed above in the first example embodiment where the first fiber optic connecter 102 is engaged with the sacrificial adapter 104. That is, as shown in FIG. 30, in the second example embodiment, the guide sleeve 206 is engaged with the first fiber optic connecter 102 in the same manner as in the first example embodiment. The only difference is that upon completion of the engaging process, the first fiber optic connecter 102 is engaged with the fiber optic adapter 105 in the second example embodiment, while the first fiber optic connector 102 is engaged with the sacrificial adapter 104 in the first example embodiment. In both cases the first optical connector 102 is in communication with the second optical connecter 107, thereby providing optical communication between the probe and the PIU.

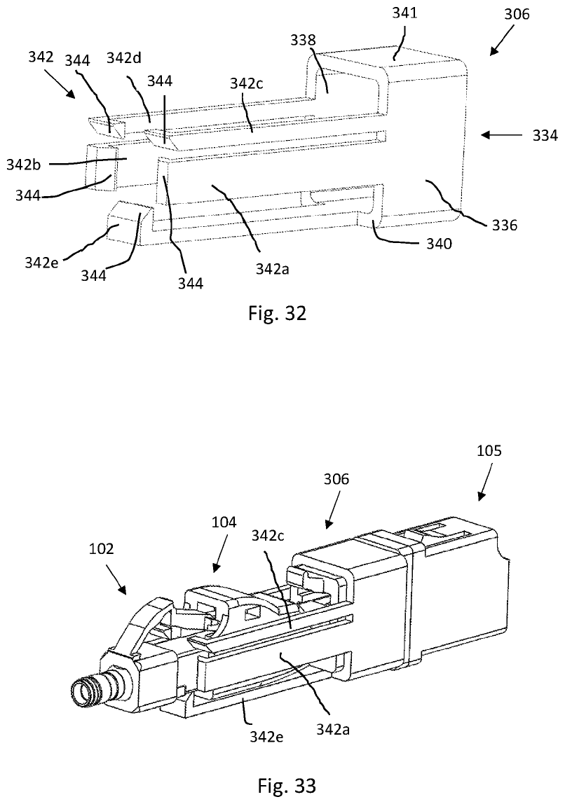

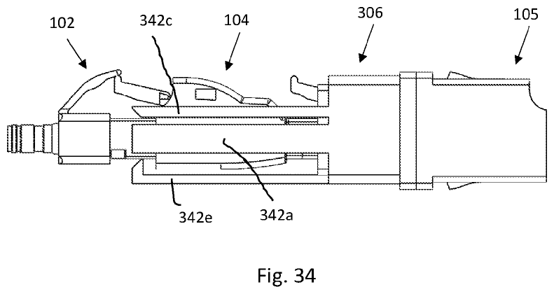

FIG. 32 shows a perspective view of a guide sleeve 306 according to a third example embodiment. FIG. 33 shows a perspective view of the guide sleeve 306 coupled with the fiber optic adapter 105, the sacrificial adapter 104 coupled with the fiber optic adapter 105, and the fiber optic connecter 102 coupled with the sacrificial adapter 104. FIG. 34 shows a side view of the guide sleeve 306, the fiber optic adapter 105, the sacrificial adapter 104, and the fiber optic connector 102 in the same engaged orientation of FIG. 33.

The third example embodiment implements the same principle as the first and second example embodiments described above. The third example embodiment is similar to the first example embodiment in that the sacrificial adapter 104 is present and is similar to the second example embodiment in that the guide sleeve 306 is coupled or integrated with fiber optic adapter 105. In other words, even though there is a sacrificial adapter 104 present in the third example embodiment, the guide sleeve 306 is nevertheless coupled or integrated with the fiber optic adapter 105 rather than the sacrificial adapter 104. As shown in FIGS. 32 34, the components are essentially the same as in the other example embodiments, except for the presence of the sacrificial adapter 104 in combination with the guide sleeve 306 being on the fiber optic adapter 105. Thus, the system in the third example embodiment similarly includes the same first fiber optic connecter 102, the same fiber optic adapter 105, and the same second fiber optic connecter (not shown), each located in the same relative position as in the first example embodiment. While not illustrated, the fiber optic connector 102, the fiber optic adapter 105, the sacrificial adapter 104, and the guide sleeve 306 may be implemented into the overall system in the same manner as the other example embodiments shown in FIGS. 2, 3, and 24.

The fiber optic adapter 102, the sacrificial adapter 104, and the fiber optic adapter 105 in the third example embodiment has the same structure as in the first and second example embodiments. Thus, the details of the fiber optic connecter 102, the sacrificial adapter 104, and the fiber optic adapter 105 are omitted herein with respect to the third example embodiment.

The guide sleeve 306 in the third example embodiment is implemented in the same manner as discussed above in the first and second example embodiments, except that the guide sleeve 406 is coupled or integral with the fiber optic adapter 105 instead of the sacrificial adapter (even though the sacrificial adapter 104 is present in the third example embodiment). The guide sleeve 306 of the third example embodiment has essentially the same structure of the guide sleeve 106 of the first example embodiment and the guide sleeve 206 of the second example embodiment, except that the size of certain elements are modified in order to account for the guide sleeve 306 being couple or integrated with the fiber optic adapter 105 instead of the sacrificial adapter 104 despite the presence of the sacrificial adapter 104.

As with the guide sleeve 106 of the first example embodiment and the guide sleeve 206 of the second example embodiment, the guide sleeve 306 of the third example embodiment similarly comprises a main body 334 having a rectangular size and shape to fit tightly around the rear end of the section 164b of the housing 160 of the fiber optic adapter 105. The main body 334 has the same lateral sides 336, 338 and transverse sides 340, 341 to form a rectangular shape. As in the first example embodiment and the second example embodiment, because the guide sleeve 306 tightly fits around (or is integral with) the fiber optic adapter 105, the profile is small enough for the combination of fiber optic adapter 105 and guide sleeve 306 to fit within the limited space of the PIU 1130.

As with the guide sleeve 106 of the first example embodiment and the guide sleeve 206 of the second example embodiment, the guide sleeve 306 of the third example embodiment further includes a plurality of flexible members 342 (342a, 342b, 342c, 342d, 342e) extending from the rear end of the main body 334. The plurality of flexible members 342a, 342b, 342c, 342d, 342e may include the same number of flexible members, extend from the same sides, have the same sloped portions 344, and define the same openings as in the guide sleeve 106 of the first example embodiment and the guide sleeve 206 of the second example embodiment.

FIG. 33 shows a perspective view of the guide sleeve 306 coupled with the fiber optic adapter 105, when the first fiber optic connector 102 is fully engaged with the fiber optic adapter 105. FIG. 34 is a side view of the same arrangement of FIG. 33. The guide sleeve 306 may be coupled or integrated with the fiber optic adapter 105 in the same manner as discussed above with respect to the guide sleeve 106 of the first example embodiment. The dimensions of the guide sleeve 306 relative to the fiber optic adapter 105 may be the same as discussed above with respect to the guide sleeve 106 in the first example embodiment. The process of the engaging the first fiber optic connecter 102 with the sacrificial adapter 104 is the same as discussed above in the first example embodiment. That is, as shown in FIGS. 33 and 34, in the third example embodiment, the guide sleeve 306 is engaged with the first fiber optic connecter 102 in the same manner as in the first example embodiment. The only difference is that because the guide sleeve 306 is coupled with the fiber optic adapter 105, and because the sacrificial adapter 104 is present, the flexible members 342a, 342b, 342c, 342d, 342e are longer than the in other example embodiments. That is, the flexible members 342a, 342b, 342c, 342d, 342e have sufficient length to extend beyond the sacrificial adapter 104 for contact with the fiber optic connecter 102. For example, in the third example embodiment, a ratio of the length of the each of flexible members 342a, 342b, 342c, 342d, 342e to the length of the main body 334 may be 4:1 to 2:1 or 3.5:1 to 2.5:1. In comparison, the length of the flexible members in the first and second example embodiments may be ¼ to ½ the length as the length of the flexible members in the first and second embodiments. The main body 334 may have the same dimensions as the maid body 134 of the first example embodiment. In all cases, the first optical connector 102 is in communication with the second optical connecter 107, after engagement thereby providing optical communication between the probe and the PIU.

While the optical connection system described above is directed to what is known in the art as an “LC” optical connector, the principles can be applied to any optical connectors known in the art. For example, in addition to LC connectors, the optical connectors can be selected from the group of connector types including SC, FC, ST, LX-5, MU, MPO, E2000, and F3000, or any other compatible connectors. In such instance concept of the guild sleeve having a plurality of flexible portions can be applied to any fiber optic adapter corresponding to one of the above connector types. SC and LC are the most common connector configurations.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. An optical connection system comprising:
a fiber optic connector,
a fiber optic adapter, and
a guide sleeve coupleable with the fiber optic adapter, the guide sleeve including a plurality of flexible members configured to guide the fiber optic connector into the fiber optic adapter to engage the fiber optic connector with the fiber optic adapter.

2. The optical connection system of claim 1,
wherein the fiber optic connector includes:
a fiber optic connector housing; and
a first fiber optic ferrule held within the fiber optic connector housing, the first fiber optic ferrule having a first fiber optic contact face, wherein the fiber optic adapter includes:
a ferrule sheath that guides the first fiber optic contact face of the first fiber optic ferrule to a second fiber optic contact face of the second fiber optic ferrule, and
wherein the plurality of flexible members are configured to guide the fiber optic connector into the fiber optic adapter such that the first fiber optic contact face contacts the second fiber optic contact face.

3. (canceled)

4. The optical connection system of claim 2, further comprising:
an additional fiber optic connector that includes the second fiber optic ferrule and the second fiber optic contact face,
wherein the ferrule sheath of the fiber optic adapter guides the second fiber optic contact face of the second fiber optic ferrule to the first fiber optic contact face of the first fiber optic ferrule.

5. The optical connection system of claim 1, wherein the plurality of flexible members comprise two or more flexible members.

6. The optical connection system of claim 1, wherein the plurality of flexible members comprise five flexible members.

7. The optical connection system of claim 1,
wherein the guide sleeve comprises a main body, and
wherein the plurality of flexible members extends from a rear end of the main body.

8. The optical connection system of claim 7,
wherein the main body comprises a first lateral side, an opposing second lateral side, and a transverse side, together defining a cavity, and
wherein the guide sleeve is coupleable with the fiber optic adapter by inserting the fiber optic adapter housing within the cavity.

9. (canceled)

10. The optical connection system of claim 7, wherein the plurality of flexible members comprise:
a first flexible member extending from a rear end of the first lateral side of the main body;
second flexible member extending from a rear end of the opposing second lateral side of the main body.

11. The optical connection system of claim 10, wherein the plurality of flexible members further comprise:
a third flexible member extending from the rear end of the first lateral side of the main body; and
a fourth flexible member extending from the rear end of the opposing second lateral side of the main body.

12. The optical connection system of claim 11, wherein the plurality of flexible members further comprise a fifth flexible member extending from a rear end of the transverse side of the main body.

13. The optical connection system of claim 12,
wherein the first flexible member opposes the second flexible member, and
wherein the fifth flexible member opposes the third flexible member and the fourth flexible member.

14. The optical connection system of claim 12, the first flexible member, the second flexible member, the third flexible member, the fourth flexible member, and the fifth flexible member each comprise a sloped portion.

15. The optical connection system of claim 14, wherein the sloped portion of each of the first flexible member, the second flexible member, the third flexible member, the fourth flexible member, and the fifth flexible member, is sloped toward a longitudinal center of the cavity.

16. The optical connection system of claim 1,
wherein each flexible member of the plurality of flexible members comprises a sloped portion, and
wherein each sloped portion is sloped toward a longitudinal center of the guide sleeve.

17. (canceled)

18. The optical connection system of claim 2,
wherein the fiber optic connector housing a first portion extending from a front of the fiber optic connector housing and a second portion extending form a rear of the fiber optic connector housing, and
where the second portion has a larger outer perimeter than the first portion.

19. The optical connection system of claim 18, wherein the plurality of flexible members are configured to resist flexing when coming into contact with the first portion of the fiber optic connector housing.

20. The optical connection system of 18, wherein the plurality of flexible members are configured to flex outwardly when coming into contact with the second portion of the fiber optic connector housing.

21. The optical connection system of claim 1, wherein the guide sleeve is coupleable with the fiber optic adapter via a friction fit.

22. An imaging system, comprising:
an imaging console;
an optical probe including a fiber optic connecter;
a patient interface unit for connecting the optical probe to the imaging console, the patient interface unit including a fiber optic adapter;
a stage for moving at least one of the optical probe and the patient interface unit toward the other; and
a guide sleeve coupled with the fiber optic adapter, the guide sleeve including a plurality of flexible members configured to guide the fiber optic connector into the fiber optic adapter to engage the fiber optic connector with the fiber optic adapter.

23. (canceled)

24. A method of making an optical connection, comprising:
moving at least one of a fiber optic connecter and a fiber optic adapter toward the other, wherein a guide sleeve is coupled with the fiber optic adapter, the guide sleeve including a plurality of flexible members; and
guiding, via the guide sleeve, the fiber optic connector into the fiber optic adapter to engage the fiber optic connector with the fiber optic adapter.

25. (canceled)
